(19) United States
(12) Patent Application Publication
(10) Pub. No.: US 2005/0045155 A1
(43) Pub. Date: Mar. 3, 2005

(54) Intake manifold with injectors and captive fuel rail

(76) Inventors: Bruce J. Harvey, Shelby Township, MI (US); James K. Vanderveen, Blenheim (CA); Ki-Ho Lee, Windsor (CA)

Correspondence Address: SIEMENS CORPORATION;INTELLECTUAL PROPERTY LAW DEPARTMENT, 170 WOOD AVENUE SOUTH, ISELIN, NJ, 08830, US

(21) Appl. No.: 10/928,613

(22) Filed: Aug. 27, 2004

Related U.S. Application Data
(60) Provisional application No. 60/498,467, filed on Aug. 28, 2003.

(51) Int. Cl. F02M 35/10

(52) U.S. Cl. 123/470; 123/184.21

(57) ABSTRACT

An intake manifold includes a lower manifold assembly that includes fuel injectors, an electrical conductor assembly for the fuel injectors, and a fuel rail retained between the lower manifold and an upper manifold. The lower manifold defines a portion of the air passage to the engine and provides for a desired positioning of the injector nozzle within the air passage. The fuel injector is sealed at a lower portion near the air passage by being integrated into the lower manifold. A support segment on the lower manifold supports the fuel rail over the fuel injectors. The upper manifold includes a retention segment that holds the fuel rail against the lower manifold and on the fuel injectors.

### BACKGROUND OF THE INVENTION

The application claims priority to U.S. Provisional Application No. 60/498,467 which was filed on Aug. 28, 2003.

This invention relates generally to a non-metallic intake manifold, and specifically to a non-metallic intake manifold including a lower manifold with an integrated wiring harness, fuel injector, an upper manifold mounted onto the lower manifold and a fuel rail retained between the upper and lower manifold.

Typically, a fuel-injected engine includes a plurality of fuel injectors mounted within an intake manifold. Each fuel injector is in fluid communication with a fuel source and is selectively actuated to meter a desired amount of fuel into a combustion chamber. Electric signals to control the fuel injectors are typically communicated through a conventional wire harness including a main connector attached to a controller and a plurality of wires that are routed to individual fuel injectors.

An intake manifold provides airflow for combination with fuel for combustion within a combustion chamber. The intake manifold is typically mounted to a cylinder head of the engine. The intake opening into the combustion chamber is sealed to prevent leakage of air that could disrupt the metered flow of air. Seals are provided that prevent air infiltration into individual passages. A fuel rail provides fuel to the various fuel injectors located at each combustion chamber. The fuel rail is another separate element that is secured with fasteners in a position to supply fuel to the fuel injectors. Disadvantageously, each separate component requires separate fastening mechanisms that can complicate assembly and contribute to the overall cost of the intake manifold.

Accordingly, it is desirable to design an integrated assembly that incorporates several different functions such as sealing, electrical, and fuel metering to provide for quality improvements, performance improvements along with decreases in cost and assembly time.

### SUMMARY OF THE INVENTION

An example intake manifold assembly according to this invention includes a lower manifold that includes fuel injectors, a lead frame for the fuel injectors, and a fuel rail retained between the lower manifold and an upper manifold.

The example intake manifold of this invention includes the lower manifold with integrated fuel injector and fuel injector wiring. The lower manifold defines a portion of an air passage to the engine and provides for a desired positioning of the injector nozzle within the air passage. The fuel injector is sealed at a lower portion near the air passage by being integrated into the lower manifold and therefore additional seals are not required. Elimination of a lower seal provides additional space utilized for optimally positioning the fuel injector within the air passage.

A support segment on the lower manifold supports the fuel rail over the plurality of fuel injectors. The upper manifold includes a retention segment that holds the fuel rail against the lower manifold and on the fuel injectors. The fuel rail is therefore held in place without additional clips or fasteners.

Accordingly, the manifold assembly of this invention provides for retention and access to the fuel rail and fuel injectors, while providing improved fuel injector position and reducing assembly and manufacturing costs.

These and other features of the present invention can be best understood from the following specification and drawings, the following of which is a brief description.

### BRIEF DESCRIPTION OF THE DRAWINGS

FIG. 1 is a cross-sectional view of a portion of an example manifold assembly according to this invention.

FIG. 2 is a perspective view of an example lower manifold assembly according to this invention.

FIG. 3 is an exploded view of the lower manifold.

FIG. 4 is a perspective view of fuel injectors and lead frame wiring.

FIG. 5 is a partial exploded view of the example manifold assembly.

### DETAILED DESCRIPTION OF THE PREFERRED EMBODIMENT

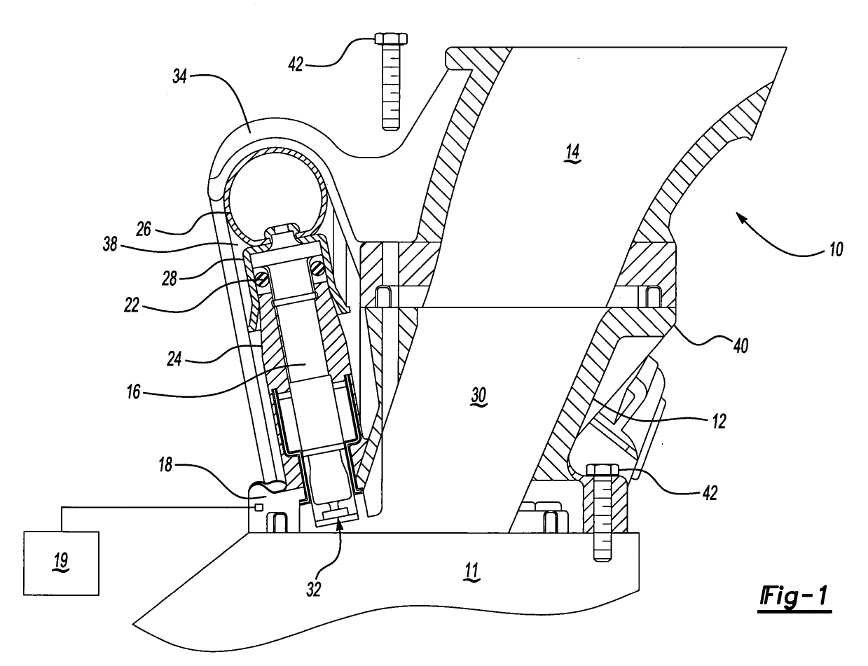

Referring to FIG. 1, a manifold assembly 10 includes an upper manifold 14 and a lower manifold 12. Fasteners 42 hold the manifold assembly 10 to an engine-mounting surface 11. The engine-mounting surface 11 is disposed on an engine cylinder head such that the manifold assembly 10 provides air and fuel to a combustion chamber of the engine. The lower manifold assembly 12 supports at least one fuel injector 16. The fuel injector 16 includes a nozzle 32 for dispensing fuel into an air passage 30. The air passage 30 is defined in part by the lower manifold 12 and further in part by the upper manifold 14.

The fuel injector 16 is mounted within a mount portion 24 of the lower manifold 12 and is in fluid communication with a fuel rail 26. The fuel rail 26 includes a cup 28 that fits over the fuel injector 16. A seal 22 provides the desired sealing required between the cup 28 and the fuel injector 16. The cup 28 is just one example of fuel rail geometry that is possible for mating to each of the fuel injectors 16. Other configurations for communicating fuel from the fuel rail 26 to the fuel injectors 16 as are known are within the contemplation of this invention.

The lower manifold 12 includes a plurality of fuel rail support segments 38. The fuel rail 26 is supported on the lower manifold 12 by these rail support segments 38 such that further brackets or fasteners are not required. The upper manifold includes a retention segment 34 that fits over the fuel rail 26. The retention segment 34 secures the fuel rail to the lower manifold 12 and onto the fuel injectors.

A wire lead frame 18 provides for electrical communication between the fuel injector 16 and a controller 19. Operation of the fuel injector 16 is as known. Further, the fuel injector 16 is as known. A worker versed in the art with the benefit of this invention would understand that fuel injectors of various types are within the contemplation of this invention.

The lower manifold 12 defines a portion of the air passage 30. It is desirable to orientate the injector nozzle 32 adjacent the air passage 30. Because the fuel injector 16 is mounted within the lower manifold 12, a lower seal is not required, thereby providing additional room for locating the fuel injector 16 in the desired location. Further, the fuel injector 16 is tilted away from the air passage 30 to provide for the desired location of the injector nozzle 32 while providing access to the top of the fuel injector 16.

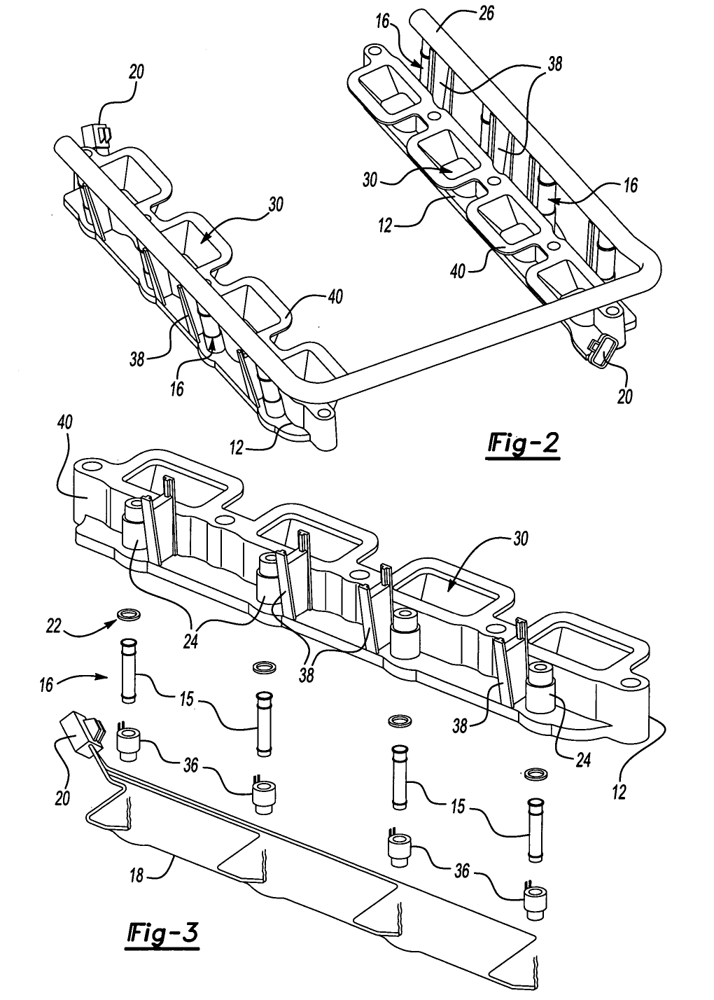

Referring to FIG. 2, two lower manifolds 12 are shown with a common fuel rail 26. The example configuration illustrated in FIG. 2 is for an eight-cylinder engine. The lower manifolds 12 are mounted to the corresponding cylinder heads to provide the desired air fuel mixture as known. Each of the lower manifolds 12 includes air passages 30 that define a portion of the air passages for the entire manifold assembly 10. The upper manifold 14 defines the remaining portions of the air passage.

The lower manifolds 12 are fabricated from a plastic material and include the lead frame 18 molded therein. The lead frame 18 is connected to each of the fuel injectors 16 and terminates at connectors 20. The connectors 20 are in turn connected to a wire harness assembly for communication with the controller 19 (FIG. 1). As appreciated, the lead frame 18 is but one example of electrical conductors that can be utilized with the lower manifold 12. Other electrical conductors for communicating electrical energy with the fuel injectors 16 are within the contemplation of this invention.

The fuel rail 26 is a tubular structure that communicates fuel to each of the injectors 16. The fuel rail 26 for the example manifold assembly 10 is generally U-shaped to provide for the common source of fuel for all of the fuel injectors 16. The fuel rail 26 is supported on the rail support segments 38 and by the engagement between the cup 28 and each of the fuel injectors 16. The sealing fit between the seal 22 and the cup 28 provide some retention of the fuel rail 26 prior to assembly of the upper manifold 14 and engagement of the retention segment 34.

The fuel rail 26 can be fabricated from any material as is known. Further, although a tubular structure for the fuel rail 26 is shown, other fuel rail cross-sections as are known are within the contemplation of this invention. In addition, although the lower manifolds 12 are shown in a configuration for an eight-cylinder engine, other configurations of the lower manifold 12 suitable for various engine configurations such as six and four cylinder engines are within the scope of this invention.

Referring to FIG. 3, the lower manifold 12 is shown in an exploded view to illustrate the various components included therein. The lower manifold 12 is a molded plastic part and includes the wire lead frame 18. The wire lead frame 18 is shown outside of the lower manifold 12. The lead frame 18 includes the connector 20 for communicating electrical signals to each of the fuel injectors 16. The fuel injectors 16 include a body portion 15 and a coil 36. The body portion 15 of the fuel injector 16 is supported and secured within the correspondingly shaped cylindrical injector mount 24 of the lower manifold 12. The injector mount 24 provides for the mounting and securing of the coil 36. The coil 36 can be integrally molded within the lower manifold 12 or can be assembled with the fuel injector 16 and supported within the injector mount 24. The shape and configuration of the injector mount 24 is adapted to the application specific fuel injector 16.

The rail support segments 38 are shown as single brackets providing support for the fuel rail 26 next to each injector mount 24. The rail support segments 38 cradles the fuel rail 26 in a position that provides for engagement and communication with each of the fuel injectors 16. The rail support segments 38 provide for the captive retention of the fuel rail 26 between the lower manifold 12 and the upper manifold 14. The fuel rail 26 remains accessible after assembly by removal of the upper manifold 14.

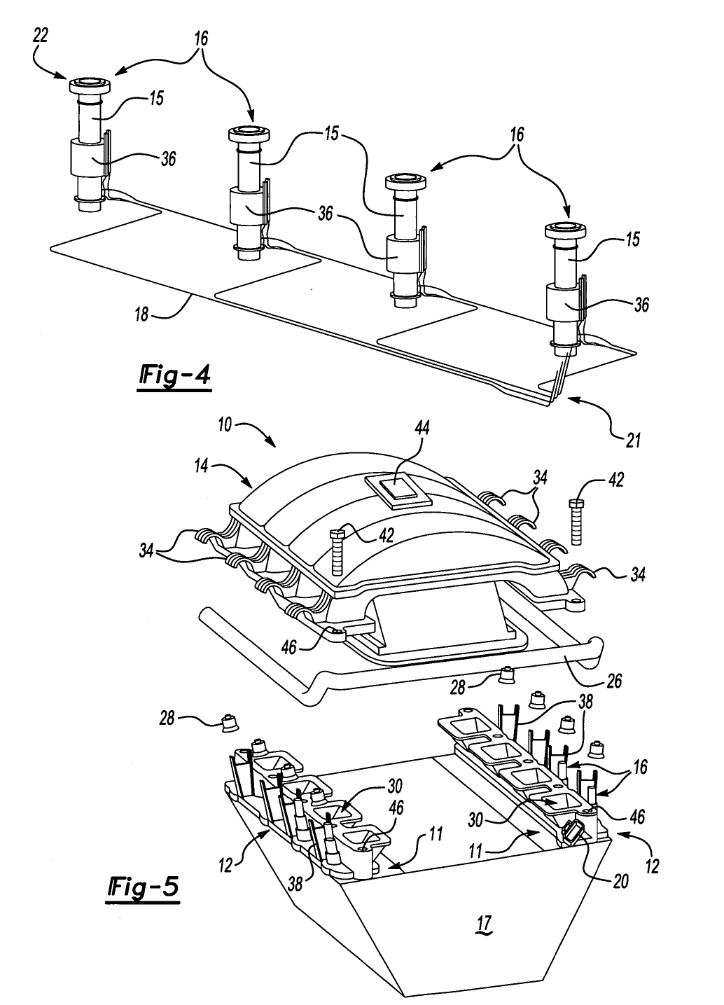

Referring to FIG. 4, the electrical circuit disposed within the lower manifold 12 is shown and includes the fuel injectors 16, the lead frame 18 and connector leads 21. The lower manifold 12 provides the volume desired for encapsulating the lead frame 18. The lead frame 18 can be of any configuration and pattern known or desired for a specific application. The lead frame 18 can be a single tier as is illustrated. A single tier lead frame includes wire segments disposed within a common plane. Further, multiple tier lead frames having wire segments on multiple planes are also within the scope of this invention. As appreciated, the height of the lower manifold 12 provides sufficient volume for the inclusion and adaptation of many different lead frame configurations.

Referring to FIG. 5, an exploded view of the example manifold assembly 10 is shown and includes the upper manifold 14 that define air passages and a mount 44 for a throttle body device (not shown). The mount 44 is adaptable for mounting of many different configurations of throttle body as are known in the art. The upper manifold 14 includes the rail retention segments 34. The rail retention segments 34 engage a surface of the fuel rail 26 to trap the fuel rail 26 against the support segments 34 on the lower manifold 12.

The upper manifold 14 covers over the top of the lower manifold 12 and retains the fuel rail 26 and the fuel injectors 16 when mounted to the engine 17. The fasteners 42 extend through openings 46 within both the upper and lower manifolds 14, 12, for securing the manifold assembly 10 to the engine 17.

Assembly of the manifold assembly 10 to the engine 17 is accomplished by placing the lower manifolds 12 on the engine-mounting surface 11 as desired. The fuel rail 26 is then assembled to the lower manifolds 12. Assembly of the fuel rail 26 includes the steps of inserting the cups 28 over each of the fuel injectors 16. The fuel rail 26 is placed in fluid communication with each of the fuel injectors 16 and sealed with the seal 22. The seal 22 seals against an inner surface of the cap 28. Because the fuel injectors 16 are mounted within the lower manifold 12 no lower seal is utilized with the fuel injector 16. The lower manifold 12 provides the desired sealing at the lower portion of the fuel injector 16.

Once the fuel rail 26 is assembled to the fuel injectors 16 and to the lower manifold 12, the upper manifold 14 is placed atop the lower manifold 12. The air passages 30 communicate with corresponding air passages within the upper manifold 14 forming the completed air passage from the mount 44 to the engine 17. The lower manifold 12 and the fuel rail 26 may be assembled first to the upper manifold 14 and then assembled to the engine 17 as a completed manifold assembly 10. In such a case, the lower manifold 12 may include clips or other known retention features. Such retention features would be temporary for holding the lower manifold 12 in place prior to assembly to the engine 17. Once assembled to the engine 17, the lower manifold 12 and the fuel rail 26 would be retained by fasteners 42 and by the retention segments 34 of the upper manifold 14.

The lower manifold 12 provides for access to the top of each injector and to the fuel rail 26. The fuel rail 26 is not specialized and a worker versed in the art with the benefit of this disclosure would understand that the upper and lower manifolds 14, 12 are capable of adaptation to conform to many application specific parameters. Clips or brackets are not required as the retention segment 34 and support segments 38 integrally formed into the upper and lower manifolds 14, 12 provide desired retention of the fuel rail 26.

The manifold assembly 10 of this invention includes the lower manifold that integrates the lead wire frame and fuel injectors into a single part. The lower manifold also carries a seal for sealing against the engine-mounting surface and defines a portion of the air passage. Further, because the fuel injector 16 is mounted within the lower manifold 12, the fuel nozzle 32 can be placed closer to an optimal location within the air passage providing an improvement in desired performance.

Although a preferred embodiment of this invention has been disclosed, a worker of ordinary skill in this art would recognize that certain modifications would come within the scope of this invention. For that reason, the following claims should be studied to determine the true scope and content of this invention.

1. An intake manifold assembly comprising:
a lower manifold including a plurality of fuel injectors;
a fuel rail mounted to said plurality of fuel injectors; and
an upper manifold holding said fuel rail on said plurality of fuel injectors.

2. The assembly as recited in claim 1, wherein said lower manifold assembly defines a portion of an airflow passage.

3. The assembly as recited in claim 1, including a segment for connecting said plurality of fuel injectors to said fuel rail.

4. The assembly as recited in claim 1, including fasteners extending through said upper and lower manifolds and into a mounting structure.

5. The assembly as recited in claim 1, wherein said lower manifold assembly includes a support segment for supporting said fuel rail.

6. The assembly as recited in claim 1, wherein said upper manifold includes a retention segment for retaining said fuel rail on said plurality of fuel injectors.

7. The assembly as recited in claim 1, wherein said lower manifold comprises electrical conductors for communicating with each of said plurality of fuel injectors.

8. The assembly as recited in claim 2, wherein each of said plurality of fuel injectors includes a nozzle portion for introducing fuel into said airflow passage.

9. The assembly as recited in claim 1, comprising two lower manifolds spaced a distance apart and a common fuel rail supported on both of said two lower manifolds.

10. The assembly as recited in claim 9, wherein said upper manifold mounts to both of said two lower manifolds, and said fuel rail is contained between said upper manifold and said two lower manifolds.

11. An intake manifold assembly comprising:
a lower manifold defining a portion of an air passage;
a plurality of fuel injectors supported within said lower manifold;
an electrical conductor assembly disposed within said lower manifold assembly and in electrical communication with said plurality of fuel injectors;
a fuel rail mounted to said plurality of fuel injectors; and
an upper manifold attachable to said lower manifold and including a retaining segment holding said fuel rail on said plurality of fuel injectors.

12. The assembly as recited in claim 11, wherein said retaining segment comprises a plurality of retaining segments disposed adjacent each of said plurality of fuel injectors.

13. The assembly as recited in claim 11, wherein said lower manifold includes support segments for supporting said fuel rail.

14. The assembly as recited in claim 11, including a mounting structure disposed between said fuel rail and each of said plurality of fuel injectors.

15. The assembly as recited in claim 11, wherein said electrical conductor assembly includes a connector.

16. A method of assembling an intake manifold, said method comprising the steps of:
a) assembling a lower manifold having an electrical conductor and a plurality of mounting structures for fuel injectors;
b) assembling a plurality of fuel injectors into corresponding mounting structures;
c) assembling a fuel rail onto the plurality of fuel injectors; and
d) mounting an upper manifold assembly onto the lower manifold and retaining the fuel rail between the upper and lower manifolds.

17. The method as recited in claim 16, wherein the lower manifold includes a support structure for supporting the fuel rail, and said step c) includes assembling the fuel rail onto the support structure of the lower manifold.

18. The method as recited in claim 17, wherein the upper manifold includes a retention structure for containing the fuel rail, and said step d) includes mounting the upper manifold assembly such that the retention structure contacts the fuel rail and contains the fuel rail between the upper and lower manifolds.

19. The method as recited in claim 16, wherein each of the plurality of fuel injectors includes a top segment and a bottom segment, and said step c) includes sealing the top segment against the fuel rail and the bottom segment with the lower manifold.
